(19) United States
(12) Patent Application Publication
(10) Pub. No.: US 2026/0222754 A1
(43) Pub. Date: Jul. 30, 2026

(54) AUDIO PROCESSING METHOD AND APPARATUS, ELECTRONIC DEVICE AND COMPUTER PROGRAM PRODUCT

(71) Applicant: Beijing Zitiao Network Technology Co., Ltd., Beijing (CN)

(72) Inventors: Leju Yan, Beijing (CN); Rui Yao, Beijing (CN)

(21) Appl. No.: 19/459,471

(22) Filed: Jan. 26, 2026

(30) Foreign Application Priority Data
Jan. 26, 2025 (WO) PCT/CN2025/075318

(51) Int. Cl. H04S 7/00; H04S 3/00

(52) U.S. Cl. CPC H04S 7/302; H04S 3/008; H04S 2400/01; H04S 2400/11

(57) ABSTRACT

The present disclosure provides an audio processing method and apparatus, an electronic device, and a computer program product. The method includes: receiving a plurality of audio streams for a real-time session, each audio stream associated with a respective speaker among a plurality of speakers. The method further incudes performing, based on a layout of the plurality of speakers displayed on a terminal, spatial audio processing on the plurality of audio streams. In addition, the method includes mixing the plurality of audio streams after the spatial audio processing, wherein the mixed audio streams are transmitted to the terminal.

### CROSS-REFERENCE TO RELATED APPLICATIONS

The application claims priority under 35 U.S.C § 119 to Application No. PCT/CN2025/075318, filed on Jan. 26, 2025, which is incorporated herein by reference in its entirety.

### FIELD

The present disclosure relates to the technical field of computers, and more specifically, to an audio processing method and apparatus, an electronic device, a computer readable storage medium, and a computer program product.

### BACKGROUND

Live streaming is a type of media that can transmit content in real time in the form of video, audio, and the like, using the Internet technology. An anchor can show his/her talents and life, or share professional knowledge or other information on the Internet by means of a special live streaming platform or software. The viewers can log in to the live streaming platform through a cellphone, a computer, or the like, to watch the live streaming and communicate with the anchor.

Multi-user co-hosting live streaming is an advanced version of the live streaming, which allows a plurality of anchors to interact online for live streaming at the same time. During the co-hosting live streaming, the participants can interact with one another and collaborate on a show. In the co-hosting scene, audio data of the anchors are typically mixed and then sent to the viewers for playing.

### SUMMARY

Embodiments of the present disclosure provide audio processing solutions for a real-time session involving multiple speakers.

In accordance with a first aspect of the present disclosure, there provides an audio processing method. The method comprises: receiving a plurality of audio streams for a real-time session, each audio stream associated with a respective speaker among a plurality of speakers; performing, based on a layout of the plurality of speakers displayed on a terminal, spatial audio processing on the plurality of audio streams; and mixing the plurality of audio streams after the spatial audio processing, wherein the mixed audio streams are transmitted to the terminal.

In a second aspect of the present disclosure, there provides an audio processing apparatus. The apparatus comprises: an audio stream receiving unit configured to receive a plurality of audio streams for a real-time session, each audio stream associated with a respective speaker among a plurality of speakers; a spatial audio processing unit configured to perform, based on a layout of the plurality of speakers displayed on a terminal, spatial audio processing on the plurality of audio streams; and a mixing unit configured to mix the plurality of audio streams after the spatial audio processing, wherein the mixed audio streams are transmitted to the terminal.

In a third aspect of the present disclosure, there provides an electronic device. The electronic device comprises: at least one processing unit; and at least one memory coupled to the at least one processing unit and storing instructions executable by the at least one processing unit, wherein the instructions, when executed by the at least one processing unit, cause the electronic device to perform an audio processing method, the method comprising: receiving a plurality of audio streams for a real-time session, each audio stream associated with a respective speaker among a plurality of speakers; performing, based on a layout of the plurality of speakers displayed on a terminal, spatial audio processing on the plurality of audio streams; and mixing the plurality of audio streams after the spatial audio processing, wherein the mixed audio streams are transmitted to the terminal.

In a fourth aspect of the present disclosure, there provides a non-transitory computer storage medium comprising machine-executable instructions that, when executed by a device, cause the device to perform the method in the first aspect of the present disclosure.

In a fifth aspect of the present disclosure, there provides a computer program product comprising machine-executable instructions that, when executed by a device, cause the device to perform the method in the first aspect of the present disclosure.

It would be appreciated that the Summary is not intended to identify key features or essential features of the present disclosure, nor is it intended to be used to limit the scope of the present disclosure. Other features of the present disclosure will be made apparent through the following description.

### BRIEF DESCRIPTION OF THE DRAWINGS

With reference to the following detailed description of the accompanying drawings, the above and other objectives, features, and advantages of the embodiments of the present disclosure will be made clearer. In the drawings, a plurality of embodiments of the present disclosure are depicted in an exemplary, but non-limiting, manner, where:

FIG. 1 illustrates a schematic diagram of an example environment in which embodiments of the present disclosure can be implemented;

FIG. 2 illustrates a schematic flowchart of an audio processing method according to embodiments of the present disclosure;

FIG. 3 illustrates a schematic block diagram of a server for performing spatial audio processing according to embodiments of the present disclosure;

FIG. 4 illustrates a schematic diagram of a spatial audio coordinate system and a layout of speakers according to embodiments of the present disclosure;

FIGS. 5A-5C illustrate a schematic diagram of a layout based on a number of speakers on a live streaming channel according to embodiments of the present disclosure, respectively;

FIG. 6 illustrates a schematic flowchart of a process of dynamically updating spatial audio processing according to embodiments of the present disclosure;

FIG. 7 illustrates a block diagram of an audio processing apparatus according to embodiments of the present disclosure; and

FIG. 8 illustrates a block diagram of an electronic device according to embodiments of the present disclosure.

Throughout the drawings, the same or similar reference numerals represent the same or similar elements.

### DETAILED DESCRIPTION OF EMBODIMENTS

Reference now will be made to various example implementations to describe the present disclosure. It would be appreciated that those implementations are described only to enable those skilled in the art to better understand and thus implement the present disclosure, without suggesting any limitation to the scope of the present disclosure.

Prior to applying the technical solution according to various embodiments of the present disclosure, the user should be informed of the type, scope of use, and use scenario of the personal information involved in an appropriate manner according to the pertinent provisions of the laws and the regulations thereof, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers or storage media that perform operations of the technical solution of the present disclosure.

As an optional implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, not formulating any limitation to the implementations of the present disclosure, and other methods compliant with the provisions of the relevant laws and regulations can also be applied to the implementations of the present disclosure.

Hereinafter, reference will be made to the accompanying drawings to describe in detail the embodiments of the present disclosure. Although some embodiments of the present disclosure are depicted in the drawings, it would be appreciated that the present disclosure could be implemented in various forms and should not be construed as being limited to the embodiments described herein. Rather, those embodiments are provided for a more thorough and complete understanding of the present disclosure. It is to be noted that the drawings and embodiments of the present disclosure are provided only exemplarily, rather than used for limiting the protection scope of the present disclosure.

As described herein, the term “includes” or similar expressions are to be read as open-ended terms that mean “includes, but is not limited to.” The term “based on” is to be read as “based at least in part on.” The term “an embodiment” or “the embodiment” is to be read as “at least one embodiment.” The terms “first,” “second,” and the like may refer to different objects or the same object unless explicitly indicated otherwise. Other definitions, explicit and implicit, may be included below.

In the current live-streaming co-hosting scenario, for stream fusion at a client or a server side, legacy operation processes include performing simple mixing processing on audio data of each anchor, and then transmitting the same to the viewer side for playing. However, such processing methods have the problem that the anchors' sounds are mixed together, without considering priorities or directions, losing the stereo effect and the spatial effect, resulting in a poor user experience.

In view of the above, embodiments of the present disclosure provide an audio processing solution for a real-time session scenario where multiple speakers are involved, which includes performing spatial audio processing on audio data of a speaker (e.g. an anchor or other participant) such that the direction of the speaker's sound received by the viewer corresponds to the speaker's position as displayed on the terminal, to thus improve the immersive experience, increase the speaker identification, and improve the audio experience during the real-time session.

In general, in order to enable the viewers watching the live streaming to receive a more three-dimensional and directional sound, and to improve the user experience and the viewership, different spatial audio processing can be performed on audio data of different speakers from the perspective of the viewers watching the live streaming (for example, directly in front of a device for playing the live stream, e.g. a cell phone, a tablet, or other terminal) based on the speakers' positions in the layout on the live streaming screen. For example, for a left speaker on the live streaming screen, audio data of the speaker is processed through the spatial audio processing as coming from the left front side; for a right speaker on the live streaming screen, audio data of the speaker is processed through the spatial audio processing as coming from the right front side. After the spatial audio processing has been completed, the audio data are mixed and transmitted to the viewers' (or users') devices.

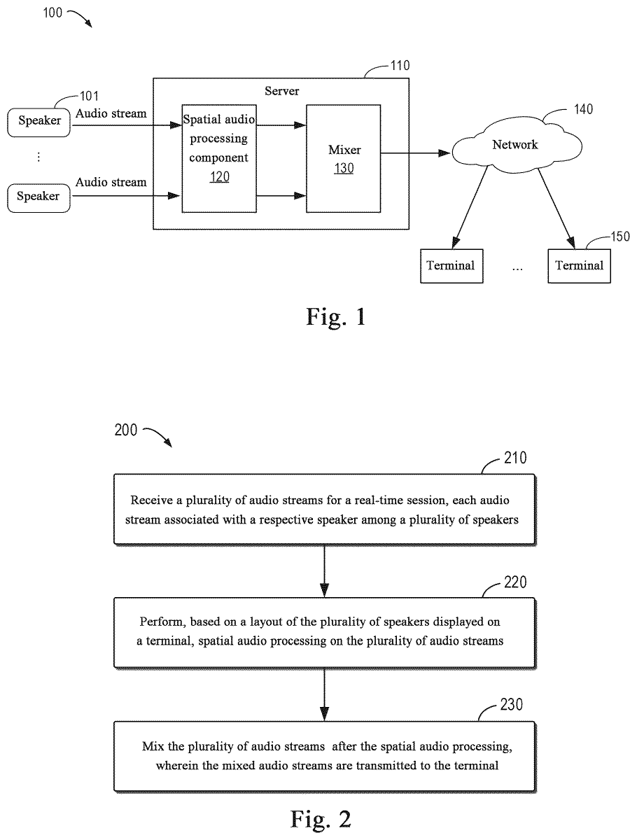

Hereinafter, reference will be made to FIGS. 1-8 to detail the embodiments of the present disclosure. It would be appreciated that, although the scene where multiple persons join in a live streaming channel is taken as an example below to describe the embodiments of the present disclosure, the embodiments described herein can be applied to other real-time session scenes, for example, a video conference with multiple participants, which is not limited in the present disclosure.

FIG. 1 is a schematic diagram of an example environment 100 where the embodiments of the present disclosure can be implemented. The environment 100 may be a co-hosing live-streaming scene, in which a plurality of anchors communicate with one another, or give a joint performance, on the same live streaming channel while users can simultaneously watch the live streaming of the plurality of anchors on devices thereof. Each anchor can occupy a part of the screen of the user's device, to form a corresponding layout of anchors. For example, if a user links or jumps to the current co-hosting scene from a live streaming channel of an anchor, the user can adapt the anchor's position to his/her preference, for example, the left side of the screen. Other anchors' positions can be determined according to the system configuration or user settings. In some implementations, the user can manually change the layout of anchors.

Referring to FIG. 1, audio streams of a plurality of speakers (e.g. anchors) 101 can be sent to a server 110. In some embodiments, the server 110 may include a Real-Time Communication (RTC) server. As shown, the server 110 includes a spatial audio processing component 120 for performing spatial audio processing on the received audio streams. In some embodiments, the spatial audio processing component 120 can perform spatial audio processing on the audio stream of the speaker 101 based on the position information of the speaker 101 in the live streaming screen, the speaking direction of the speaker, and the direction from which the viewer receives the sound. In some embodiments, assuming that the speaking direction of the speaker is always the front direction, the viewers will always receive the sound from the front side. The spatial audio processing component 120 can transform the position information into spatial audio parameters, and input the latter into an audio positioning algorithm (e.g. the Head-Related Transfer Function (HRTF) or the like), to generate audio streams after the spatial audio processing. The position information of the speaker may depend on the layout on the device for playing the live streaming. For example, if an anchor A is on the left side of a live streaming screen of a device while being on the right side, or other position, of a further screen, corresponding different processing is required for the audio stream of the anchor A.

The server 110 further includes a mixer 130. The mixer 130 receives a plurality of audio streams having subjected to the spatial audio processing, and then fuse the audio streams together, to obtain the mixed audio stream. Since those audio streams have a spatial directional characteristic, the mixed audio stream brings about a stereo effect. The mixer 130 can combine the audio streams based on the layout of the speakers on the live streaming screen, to form a mixed audio stream. For example, in a scene of two anchors, the layout on the live streaming screen may be that an anchor A is on the left side while an anchor B is on the right side, or that the anchor A is on the right side while the anchor B is on the left side; the mixer 130 can fuse the audio stream of the anchor A on the left side and the audio stream of the anchor B on the right side after the two audio streams have subjected to the spatial audio processing, or fuse the audio stream of the anchor A on the right side and the audio stream of the anchor B on the left side after the two audio streams have subjected to the spatial audio processing. In other words, the mixer 130 mixes the processed audio streams, to cause the mixed audio stream match with the live streaming screen.

The server 110 can send the mixed audio stream to a network 140, and the network 140 then delivers the mixed audio stream to terminals 150. The network 140 may be, for example, a Content Delivery Network (CDN). Accordingly, the terminal 150 can receive an audio stream matching the layout of the speakers on the live streaming screen.

It is worth noting that the environment 100 as shown in FIG. 1 is provided only as an example, and the embodiments of the present disclosure can be implemented in different environments such as a video conference. The environment 100 may include more or fewer components. For example, the server 110 may further include components for encoding and decoding audio streams, and the like.

FIG. 2 illustrates a schematic flowchart of an audio processing method 200 according to embodiments of the present disclosure. In some embodiments, the method 200 can be implemented by the server 110 as shown in FIG. 1. It would be appreciated that the method 200 may include additional actions not shown, and/or omit the actions shown therein. The scope of the present disclosure is not limited in the aspect.

In block 210, the method 200 includes: receiving a plurality of audio streams for a real-time session, each audio stream associated with a respective speaker among a plurality of speakers. For example, in the co-hosting scene, the server 110 can receive audio streams from a plurality of anchors, where each audio stream includes audio data of a respective anchor.

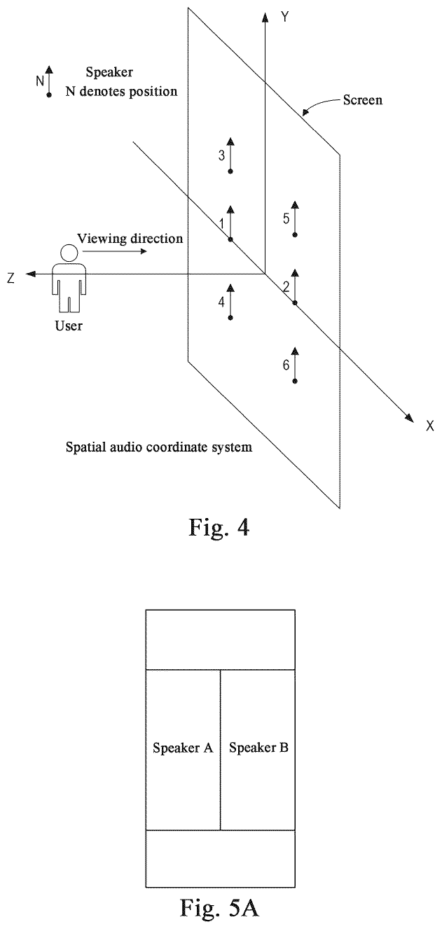

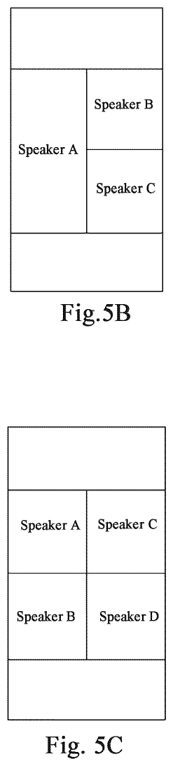

In block 220, the method 200 includes: performing, based on a layout of the plurality of speakers displayed on a terminal, spatial audio processing on the plurality of audio streams. The position of each speaker on the live streaming screen can be used to determine how to process the audio stream of the speaker. In some embodiments, the server 110 can determine spatial audio parameters of each speaker based on a layout of the speakers, where the layout can be determined based on a number of current co-hosting speakers. Then, the server 110 performs spatial audio processing on associated audio streams based on the spatial audio parameters. For example, for the audio positioning algorithm, it is required to input coordinates of a viewer, coordinates of a sound source, a listening direction of the viewer, an emitting direction of the sound source, and the like, in a spatial coordinate system; in the case, the server 110 needs to determine the aforementioned information and input the same to the audio positioning algorithm. Hereinafter, details will be provided in conjunction with FIGS. 4 and 5A-5C.

In block 230, the method 200 includes: mixing the plurality of audio streams after the spatial audio processing, wherein the mixed audio streams are transmitted to the terminal.

In some embodiments, for an audio stream, the server 110 can generate a plurality of audio streams after spatial audio processing, where each processed audio stream corresponds to a different position of a corresponding speaker in the layout of the live streaming screen. The server 110 can select, based on the layout, a processed audio stream from the plurality of processed audio streams for mixing. The mixed audio stream can be delivered to a terminal 150 having the layout applied thereon.

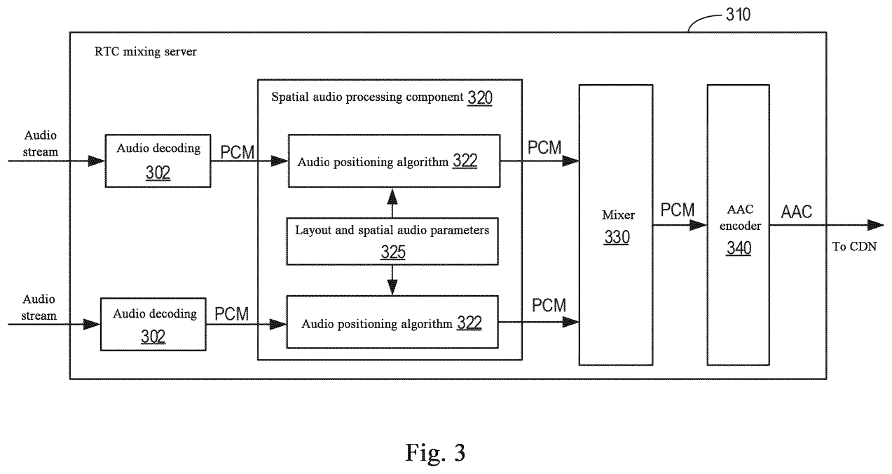

FIG. 3 illustrates a schematic block diagram of a server 310 for implementing spatial audio processing according to embodiments of the present disclosure. The server 310 may be an example implementation of the server 110 in FIG. 1, for example, an RTC fusion server.

As shown therein, the server 310 includes an audio decoding component 302 for performing a decoding operation on the received audio stream, to obtain decoded audio data, for example, in a Pulse Code Modulation (PCM) format.

The server 310 further includes a spatial audio processing component 320 which includes an audio positioning algorithm 322, and stores information about layout and spatial audio parameters 325. The audio positioning algorithm 322 may be, for example, an HRTF algorithm, a Vector Base Amplitude Panning (VBAP) algorithm, a Sound Field Synthesis (SFS) algorithm, and the like. For each decoded audio stream, the audio positioning algorithm 320 processes the audio stream based on the respective spatial audio parameters.

The processed audio streams are provided to the mixer 330. The mixer 330 combines the audio streams with spatial information based on the layout, to obtain the mixed audio stream, and then provides the same to an Advanced Audio Coding (AAC) encoder 340. Specifically, a plurality of processed audio streams are generated after the audio stream of the speakers have been subjected to the spatial audio processing, where each processed audio stream corresponds to a corresponding position of the speaker in the layout. The mixer 300 can select, based on the layout, a processed audio stream from the plurality of processed audio streams for mixing.

The audio stream encoded by the ACC encoder 340 can be sent to the CDN for delivery to the terminal.

For ease of description, the HRTF algorithm is taken as an example to describe in detail how to determine the spatial audio parameters. In order to determine respective spatial audio parameters of the plurality of speakers, the server 310 can determine, based on the position of the speaker in the layout, a virtual spatial position of the speaker relative to a terminal user (i.e., the viewer). The virtual spatial position may include coordinates in the spatial audio coordinate system.

FIG. 4 illustrates a schematic diagram of a spatial audio system and a layout of speakers according to embodiments of the present disclosure. As shown therein, in the case that a user views the screen from the front side, there is a plurality of candidate positions of a speaker on the screen, specifically: Position 1 corresponding to the left side of the user, Position 2 corresponding to the right side of the user, Position 3 corresponding to the upper left side of the user, Position 4 corresponding to the lower left side of the user, Position 5 corresponding to the upper right side of the user, and Position 6 corresponding to the lower right side of the user. It would be appreciated that the candidate positions on the screen may be different from those mentioned above, and there may be more or fewer candidate positions. In some embodiments, the layout of speakers is determined from those candidate positions based on a number of speakers on the current live streaming channel.

FIGS. 5A-5C illustrate a schematic diagram of a layout based on a number of speakers on a live streaming channel according to embodiments of the present disclosure, respectively. FIG. 5A illustrates an example layout in a case of two speakers, where Speaker A is located on a left position (i.e., Position 1), and Speaker B is located on a right position (i.e., Position 2). FIG. 5B illustrates an example layout in a case of three speakers, where Speaker A is located on a left position (i.e., Position 1), Speaker B is located on an upper right position (i.e., Position 5), and Speaker C is located on a lower right position (i.e., Position 6). FIG. 5C illustrates an example layout in a case of four speakers, where Speaker A is located on an upper left position (i.e., Position 3), Speaker B is located on a lower left position (i.e., Position 4), Speaker C is on an upper right position (i.e., Position 5), and Speaker 4 is located on a lower right position (i.e. Position 6).

In some embodiments, if the speaker is a main speaker on the terminal, it can be determined that the position of the speaker is a left position, an upper left position, or a lower left position (i.e., one of Positions 1, 3 and 4). The main speaker indicates that the user enters the co-hosting scene from the live streaming channel of the speaker.

Next, description will be made to the example method of computing spatial coordinates of Positions 1-6. In the spatial coordinate system of FIG. 4, the horizontal direction in the screen is an X axis, the longitudinal direction is a Y axis, and the direction perpendicular to the screen is a Z axis (the user direction is positive). Assuming that the coordinates of the user are (0, 0, L), where L is greater than 0, it can be set that the coordinates of Position 1 are (0, −A, 0), and the coordinates of Position 2 are (0, A, 0), where A is greater than 0. In addition, it is assumed that the distance from each of Positions 3, 4, 5 and 6 to the X axis is equal to A.

As seen above, L and A jointly determine the size of the angle θ (theta) between sounds of speakers heard by the user in different directions (relative to the Z-axis), and the specific relationship is theta=atan (A/L), atan is an inverse function of the tangent function tan. In some embodiments, the corresponding values of A and L can be derived based on the target angle. For example, assuming that the target angle theta is 20 degrees, A/L=tan 20°≈0.364. Therefore, as long as the ratio of A to L can remain constant, the direction of the sound can be kept unchanged. It is supposed that L=1. According to the above description, if the angle between the speaker and the user is theta, spatial coordinates of Positions 1 to 6 can be determined as follows:

| | |
|---|---|
| 1 | 2 |
| (0, −tan(theta), 0) | (0, tan(theta), 0) |
| 3 | 4 |
| (tan(theta)/sqrt(2), −tan(theta)/sqrt(2), 0) | (−tan(theta)/sqrt(2), −tan(theta)/sqrt(2), 0) |
| 5 | 6 |
| (tan(theta)/sqrt(2), tan(theta)/sqrt(2), 0) | (tan(theta)/sqrt(2), −tan(theta)/sqrt(2), 0) |

In some embodiments, when determining the virtual spatial position of the speaker relative to the terminal user, the server 310 can determine the virtual spatial position of the speaker relative to the user based on the position of the speaker in the layout and the virtual listening angle (i.e., theta) of the user. Specifically, the effect of the spatial audio can be adjusted by setting different angles theta. If an angle for intense spatial audio is required, a great theta can be set; if it is only expected to slightly differentiate the spatial positions, a small theta can be set. In some embodiments, in order to reduce the computing complexity, only the horizontal spatial information is considered while the vertical spatial information may be ignored. That is, the same spatial audio parameters relative to the X axis are applied for the speakers. For example, the parameters of Position 1 are applied for all the left speakers, and the parameters of Position 2 are applied for all the right speakers.

In some embodiments, determining the spatial audio parameters of the speaker may include determining an orientation of the user relative to the terminal. The orientation of the user relative to the terminal may be a direction of directly facing the screen, and the respective vector information can then be input to the audio positioning algorithm 322.

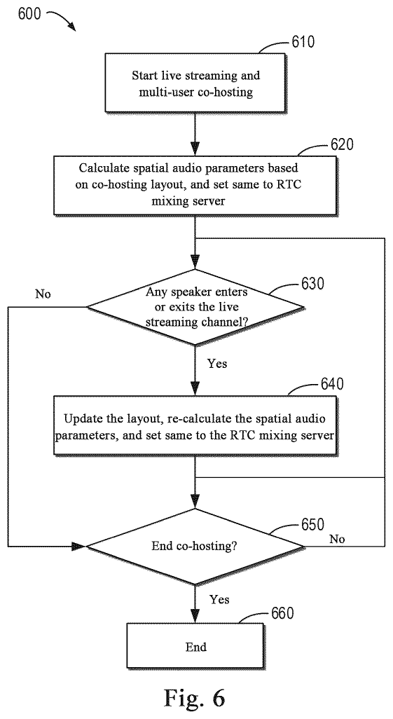

FIG. 6 illustrates an example flowchart of a process 600 of dynamically updating spatial audio processing according to embodiments of the present disclosure. The process 600 can be implemented by, for example, the server 110 as shown in FIG. 1. It would be appreciated that the process 600 may include additional actions not shown, and/or may omit the actions shown therein. The scope of the present disclosure is not limited in the aspect.

In block 610, determining to start live streaming and multi-user co-hosting, which indicates that spatial audio processing needs to be performed on audio streams of a plurality of speakers.

In block 620, computing spatial audio parameters based on a co-hosting layout displayed on the live streaming screen, and setting the same to an RTC fusion server; and then, performing spatial audio processing and mixing on audio streams of the speakers based on the spatial audio parameters.

In block 630, determining whether a speaker enters or exits the live streaming channel; if there is a speaker entering or exiting the live streaming channel, which indicates that the layout will be changed, the process 600 proceeding to block 640 to update the layout, re-compute spatial audio parameters and set the same to the RTC fusion server.

In block 650, determining to end the co-hosting; if yes, proceeding to block 660 which indicates an end; otherwise, returning to block 630 to further determine whether a speaker enters or exits the live streaming channel.

The description of the example embodiments of the present disclosure have been made with reference to FIGS. 1-6. As compared with the prior art, the embodiments of the present disclosure include performing spatial audio processing on a plurality of audio streams in a real-time session such that the direction of the speaker's sound can correspond to the speaker's position displayed on the terminal, to thus improve the immersive experience, increase the speaker identification, and improve the audio experience during a real-time session.

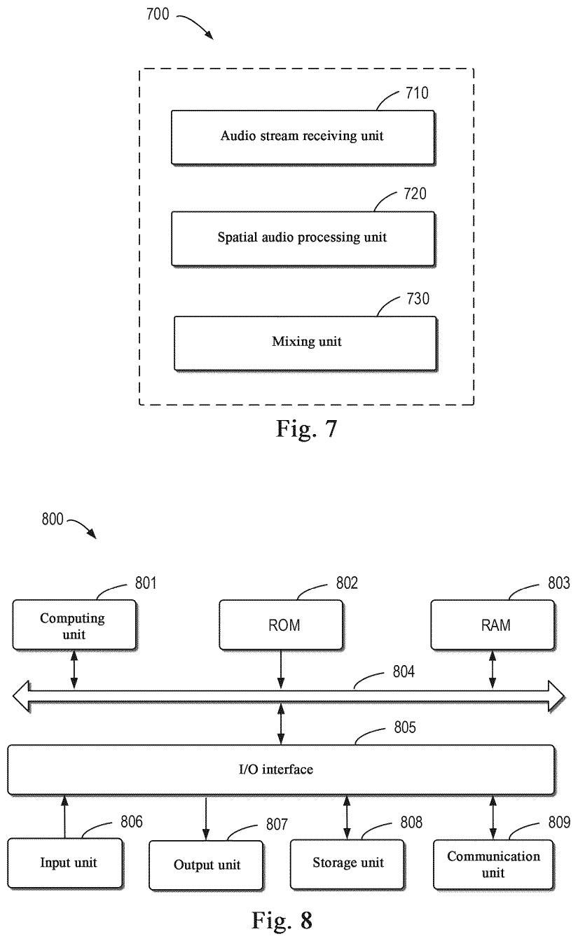

FIG. 7 illustrates an example block diagram of an audio processing apparatus 700 according to embodiments of the present disclosure. The apparatus 700 can be used to implement the method 200 described with reference to FIG. 2. As shown therein, the apparatus 700 includes an audio stream receiving unit 710, a spatial audio processing unit 720, and a mixing unit 730. The audio stream receiving unit 710 is configured to receive a plurality of audio streams for a real-time session, each audio stream associated with a respective speaker among a plurality of speakers. The spatial audio processing unit 720 is configured to perform, based on a layout of the plurality of speakers displayed on a terminal, spatial audio processing on the plurality of audio streams. The mixing unit 730 is configured to mix the plurality of audio streams after the spatial audio processing, where the mixed audio streams are transmitted to the terminal.

In some embodiments, performing the spatial audio processing on the plurality of audio streams comprises: determining, based on a number of the plurality of speakers, the layout of the plurality of speakers displayed on the terminal; determining, based on the layout, spatial audio parameters of each of the plurality of speakers; and performing, based on the spatial audio parameters, the spatial audio processing on an associated audio stream.

In some embodiments, determining, based on the layout, the spatial audio parameters of each of the plurality of speakers may comprise: determining, based on a position of a speaker in the plurality of speakers in the layout, a virtual spatial position of the speaker relative to a user of the terminal.

In some embodiments, determining, based on the layout, the spatial audio parameters of each of the plurality of speakers may further comprise: determining an orientation of the user relative to the terminal.

In some embodiments, determining the virtual spatial position of the speaker in the plurality of speakers relative to the user of the terminal may comprise: determining, based on the position of the speaker in the layout and a virtual listening angle of the user, the virtual spatial position of the speaker relative to the user.

In some embodiments, the position of the speaker in the layout comprises one of the following: an upper left position, a left position, a lower left position, an upper right position, a right position, and a lower right position.

In some embodiments, in response to that the speaker is a main speaker of the terminal, it is determined that the position of the speaker is the left, the upper left, or the lower left position.

In some embodiments, a plurality of processed audio streams are generated after the spatial audio processing of the audio stream of the speaker in the plurality of speakers, and each processed audio stream corresponds to a different position of the speaker in the layout, and mixing the plurality of audio streams after the spatial audio processing may comprise: selecting, based on the layout, a processed audio stream from the plurality of processed audio streams for mixing.

In some embodiments, in response to determining that a new speaker joins in, or a speaker exits the real-time session, the layout is updated; and the spatial audio processing is re-performed on audio streams of the live streaming channel, based on the updated layout.

It is worth noting that more actions or steps as shown in FIGS. 1-6 can be implemented by the apparatus 700 as shown in FIG. 7. For example, the apparatus 700 may include more modules or units to implement the actions or steps described above, or some units or modules shown in FIG. 7 can be further configured to implement the actions or steps described above. Details are omitted here for brevity.

FIG. 8 illustrates an example block diagram of an example device 800 that can implement embodiments of the present disclosure. As shown therein, the device 800 may include a computing unit 801 which can execute various actions and processing based on programs stored in a Read Only Memory (ROM) 802 or a program loaded from a storage unit 806 to a Random Access Memory (RAM) 803. RAM 803 stores therein various programs and data required for operations of the device 800. The computing unit 801, the ROM 802, and the RAM 803 are connected to one another via a bus 804. An input/output (I/O) interface 805 is also connected to the bus 804.

A plurality of components in the device 800 may be connected to the I/O interface 805, including: an input unit 806 including, for example, a keyboard, a mouse, and the like; an output unit 807 including various types of displays, loudspeakers, and the like; a storage unit 808 including, for example, a magnetic disk, a compact disc, or the like; and a communication unit 809, for example, a network card, a modem, a wireless communication transceiver, or the like. The communication unit 809 can allow the device 800 to exchange information/data with other devices through a computer network such as Internet, and/or various kinds of telecommunication networks.

The computing unit 801 may be various types of general purpose and/or specific purpose processing components having a processing and computing capability. Some examples of the computing unit 801 include, but are not limited to, a Central Processing Unit (CPU), a Graphics Processing Unit (GPU), various types of specific-purpose Artificial Intelligence (AI) computing chips, various types of computing units having machine learning model algorithms run thereon, a Digital Signal Processor (DSP), any appropriate processor, controller, microcontroller, or the like. The computing unit 801 can execute various methods and processing described above, for example, the method 200. For example, the method 200 may be implemented as computer software programs that are tangibly included in a machine readable medium, e.g., the storage unit 808. In some embodiments, part or all of the computer programs may be loaded and/or mounted onto the device 800 via ROM 802 and/or communication unit 809. When the computer program is loaded to the RAM 803 and executed by the computing unit 801, one or more steps of the method 200 as described above may be executed. Alternatively, in other embodiments, the computing unit 801 may be configured in any other appropriate manners (for example, by means of firmware) to perform the method 200.

In some embodiments, the method and process described above may be implemented as a computer program product. The computer program product may include a computer readable storage medium having stored thereon computer readable program instructions for performing various aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a Random Access Memory (RAM), a Read-Only Memory (ROM), an Erasable Programmable Read-Only Memory (EPROM or Flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals sent through a wire.

Computer readable program instructions described herein can be downloaded to corresponding computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the corresponding computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a Local Area Network (LAN) or a Wide Area Network (WAN), or the connection may be made to an external computer (for example, through the Internet using an Internet Service Provider). In some embodiments, electronic circuitry including, for example, programmable logic circuitry, Field-Programmable Gate Arrays (FPGAs), or Programmable Logic Arrays (PLAs) may execute the computer readable program instructions by utilizing state information of the computer readable program instructions to personalize the electronic circuitry, in order to perform aspects of the present disclosure.

These computer readable program instructions may be provided to a processing unit of a general purpose computer, special purpose computer, or other programmable data processing device to produce a machine, such that the instructions, when executed via the processing unit of the computer or other programmable data processing device, create apparatuses for implementing the functions/actions specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored thereon includes an article of manufacture including instructions which implement aspects of the functions/actions specified in the flowchart and/or block diagram block or blocks.

The computer readable program instructions may also be loaded onto a computer, other programmable data processing devices, or other devices to cause a series of operational steps to be performed on the computer, other programmable devices or other devices to produce a computer implemented process, such that the instructions which are executed on the computer, other programmable devices, or other devices implement the functions/actions specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which includes one or more executable instructions for implementing the specified logical function(s). In some alternative implementations, the functions noted in the block may occur out of the order noted in the images. For example, two blocks in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for audio processing, comprising:
receiving a plurality of audio streams for a real-time session, each audio stream associated with a respective speaker among a plurality of speakers;
performing, based on a layout of the plurality of speakers displayed on a terminal, spatial audio processing on the plurality of audio streams; and
mixing the plurality of audio streams after the spatial audio processing, wherein the mixed audio streams are transmitted to the terminal.

2. The method of claim 1, wherein performing the spatial audio processing on the plurality of audio streams comprises:
determining, based on a number of the plurality of speakers, the layout of the plurality of speakers displayed on the terminal;
determining, based on the layout, spatial audio parameters of each of the plurality of speakers; and
performing, based on the spatial audio parameters, the spatial audio processing on an associated audio stream.

3. The method of claim 2, wherein determining, based on the layout, the spatial audio parameters of each of the plurality of speakers comprises:
determining, based on a position of a speaker in the plurality of speakers in the layout, a virtual spatial position of the speaker relative to a user of the terminal.

4. The method of claim 3, wherein determining, based on the layout, the spatial audio parameters of each of the plurality of speakers further comprises:
determining an orientation of the user relative to the terminal.

5. The method of claim 3, wherein determining the virtual spatial position of the speaker in the plurality of speakers relative to the user of the terminal comprises:
determining, based on the position of the speaker in the layout and a virtual listening angle of the user, the virtual spatial position of the speaker relative to the user.

6. The method of claim 3, wherein the position of the speaker in the layout comprises one of the following: an upper left position, a left position, a lower left position, an upper right position, a right position, and a lower right position.

7. The method of claim 6, further comprising determining that the position of the speaker is the left, the upper left, or the lower left position in response to that the speaker is a main speaker of the terminal.

8. The method of claim 1, wherein a plurality of processed audio streams are generated after the spatial audio processing of the audio stream of the speaker in the plurality of speakers, and each processed audio stream corresponds to a different position of the speaker in the layout, and
wherein mixing the plurality of audio streams after the spatial audio processing comprises: selecting, based on the layout, a processed audio stream from the plurality of processed audio streams for mixing.

9. The method of claim 1, further comprising:
in response to determining that a new speaker joins in, or a speaker exits the real-time session, updating the layout; and
re-performing, based on the updated layout, the spatial audio processing on audio streams of the live streaming channel.

10. An electronic device, comprising:
at least one processing unit; and
at least one memory coupled to the at least one processing unit and storing instructions executable by the at least one processing unit, wherein the instructions, when executed by the at least one processing unit, cause the electronic device to perform an audio processing method, the method comprising:
receiving a plurality of audio streams for a real-time session, each audio stream associated with a respective speaker among a plurality of speakers;
performing, based on a layout of the plurality of speakers displayed on a terminal, spatial audio processing on the plurality of audio streams; and
mixing the plurality of audio streams after the spatial audio processing, wherein the mixed audio streams are transmitted to the terminal.

11. The electronic device of claim 10, wherein performing the spatial audio processing on the plurality of audio streams comprises:
determining, based on a number of the plurality of speakers, the layout of the plurality of speakers displayed on the terminal;
determining, based on the layout, spatial audio parameters of each of the plurality of speakers; and
performing, based on the spatial audio parameters, the spatial audio processing on an associated audio stream.

12. The electronic device of claim 11, wherein determining, based on the layout, the spatial audio parameters of each of the plurality of speakers comprises:
determining, based on a position of a speaker in the plurality of speakers in the layout, a virtual spatial position of the speaker relative to a user of the terminal.

13. The electronic device of claim 12, wherein determining the virtual spatial position of the speaker in the plurality of speakers relative to the user of the terminal comprises:
determining, based on the position of the speaker in the layout and a virtual listening angle of the user, the virtual spatial position of the speaker relative to the user.

14. The electronic device of claim 12, wherein determining, based on the layout, the spatial audio parameters of each of the plurality of speakers further comprises:
determining an orientation of the user relative to the terminal.

15. The electronic device of claim 12, wherein the position of the speaker in the layout comprises one of the following: an upper left position, a left position, a lower left position, an upper right position, a right position, and a lower right position.

16. The electronic device of claim 15, the method further comprising determining that the position of the speaker is the left, the upper left, or the lower left position in response to that the speaker is a main speaker of the terminal.

17. The electronic device of claim 10, wherein a plurality of processed audio streams are generated after the spatial audio processing of the audio stream of the speaker in the plurality of speakers, and each processed audio stream corresponds to a different position of the speaker in the layout, and
wherein mixing the plurality of audio streams after the spatial audio processing comprises: selecting, based on the layout, a processed audio stream from the plurality of processed audio streams for mixing.

18. The electronic device of claim 10, the method further comprising:
in response to determining that a new speaker joins in, or a speaker exits the real-time session, updating the layout; and
re-performing, based on the updated layout, the spatial audio processing on audio streams of the live streaming channel.

19. A computer program product comprising machine-executable instructions that, when executed by a device, cause the device to perform a method comprising:
receiving a plurality of audio streams for a real-time session, each audio stream associated with a respective speaker among a plurality of speakers;
performing, based on a layout of the plurality of speakers displayed on a terminal, spatial audio processing on the plurality of audio streams; and
mixing the plurality of audio streams after the spatial audio processing, wherein the mixed audio streams are transmitted to the terminal.

20. The computer program product of claim 19, wherein performing the spatial audio processing on the plurality of audio streams comprises:
determining, based on a number of the plurality of speakers, the layout of the plurality of speakers displayed on the terminal;
determining, based on the layout, spatial audio parameters of each of the plurality of speakers; and
performing, based on the spatial audio parameters, the spatial audio processing on an associated audio stream.
